(19) United States
(12) Patent Application Publication
(10) Pub. No.: US 2012/0048055 A1
(43) Pub. Date: Mar. 1, 2012

(54) Bicycle Handlebar Grip

(75) Inventors: Andreas KRAUSE, Koblenz (DE); Kim TOFAUTE, Lahnstein (DE)

(73) Assignee: RTI SPORTS VERTRIEB VON SPORTARTIKELN GMBH, Koblenz (DE)

(21) Appl. No.: 13/221,247

(22) Filed: Aug. 30, 2011

(30) Foreign Application Priority Data
Aug. 30, 2010 (DE) 202010011987.1

(51) Int. Cl. B62K 21/26

(52) U.S. Cl. 74/551.9

(57) ABSTRACT

A bicycle handlebar grip which is in particular suitable for mountain bikes and/or trekking bikes comprises a grip element (10) and a supporting element (12) for the heel of the hand connected with said grip element (10). The supporting element (12) for the heel of the hand comprises areas (30,32) of different flexibilities. In a preferred embodiment, the different flexibilities are realized by skeleton-type reinforcement elements (24,26) arranged inside the supporting element (12) for the heel of the hand.

### FIELD OF THE INVENTION

The present invention relates to a bicycle handlebar grip and in particular to a bicycle handlebar grip for mountain bikes and trekking bikes.

### BACKGROUND OF THE INVENTION

### Description of the Prior Art

During a bicycle ride the hand of the bicyclist is subjected to large stresses. This applies in particular when riding on uneven routes. These stresses frequently lead to aching wrists and numb fingers. Thus it has been common practice for a long time to configure bicycle handles such that they comprise, in addition to a grip element, a supporting element for the heel of the hand (hereinafter referred to as supporting element). Here, as with conventional bicycle handlebar grips, the grip element is of an essentially cylindrical configuration, for example, and, when mounted, surrounds the bicycle handlebar. The grip element has connected therewith the supporting element. The supporting element is a projection extending towards the bicyclist and allowing the bicyclist to rest his heel of the hand flat on said projection. Such bicycle handlebar grips have been known for a long time and are described in DE 688 541, for example.

A bicycle handlebar grip which also comprises a supporting element and ensures a very good ergonomic hand posture is described in EP 1 712 460. This bicycle handlebar grip comprises an inner sleeve of an essentially cylindrical configuration and made of a hard material. Said sleeve is surrounded by a grip element made of a softer material. Thus a damping effect and hence an ergonomic improvement can be attained.

The sleeve made of a hard plastic material is connected with a wing-shaped projection. Said projection is surrounded by the supporting element. The wing-shaped projection is thus arranged inside the supporting element and is of skeleton-type configuration corresponding to a reinforcement element.

Thus it is possible to make the supporting element, too, from a soft plastic material and further to provide a relatively large supporting element. Hence the heel of the hand can be rested in an extremely ergonomic manner.

To prevent the bicycle handlebar grip from being rotated due to the force acting upon the supporting element, a clamping means, such as a clip which is in particular of ring-shaped configuration, is provided. Said clip surrounds the sleeve in an outer edge area where the sleeve comprises a sleeve slot. With the aid of a clamping element, such as a screw, the clip-type clamping means can be tightened such that the inner sleeve diameter in the area of the sleeve slot is reduced. Thus the bicycle handlebar grip can be clampingly connected with the handlebar such that the bicycle handlebar grip is prevented from being rotated even when a large force acts upon the supporting element. To further improve the ergonomics, the supporting element of the bicycle handlebar grip described in EP 1 712 460 is configured such that the supporting element extends into the clamping area and thus the clamping means is integrated in the bicycle handlebar grip and/or forms part of the holding surface.

### SUMMARY OF THE INVENTION

It is an object of the present invention to provide a bicycle handlebar grip which is in particular suitable for mountain bikes and trekking bikes and which offers further improvement of the ergonomics.

According to the present invention, this object is achieved by the features of claim 1.

The bicycle handlebar grip according to the present invention comprises a grip element. Said grip element preferably is an essentially cylindrical element made of plastic material, which, when mounted, surrounds the bicycle handlebar and is gripped by the fingers. Further, the bicycle handlebar grip according to the present invention comprises a supporting element for the heel of the hand (hereinafter referred to as supporting element) which is connected with the grip element. When mounted, the supporting element extends towards the bicyclist such that the heel of the hand is supported by said supporting element. Thus, in particular when riding on uneven routes and downhill, a considerable relaxation of the wrist is attained. Here, the supporting element is preferably of arcuate configuration, as seen from top. According to the present invention, the ergonomics of the bicycle handlebar grip is improved in that the supporting element comprises areas of different flexibilities. Here, the flexibility of areas of the supporting element is provided such that in the individual areas the supporting element shows different flexibilities and/or different compliances when compressive forces are applied by the heel of the hand. Here, in particular an inner area of the supporting element, i.e. that area where the area of the heel of the hand near the thumb is supported, is more flexible than the outer area. This flexibility leads to a further relaxation of the wrists since in particular in this area large forces and shocks occur.

According to the present invention, the different flexibilities of the supporting element can be attained by using different materials in the different areas. In addition to selection of the suitable material, said material may have different geometrical shapes and in particular different thicknesses. Further, by selecting different densities of the material a lower or higher flexibility can be attained, for example.

In a particularly preferred embodiment of the bicycle handlebar grip according to the present invention, at least one reinforcement element is provided inside the supporting element. Here, the different flexibilities in the individual areas are preferably realized with the aid of the at least one reinforcement element. This offers the essential advantage that the reinforcement element can be completely surrounded by a plastic material. Here, the material can be selected independently of the required flexibility such that damping materials and/or materials with a high skid resistance etc. can be selected, for example. Such a reinforcement element can in particular be completely surrounded by a softer plastic material.

For example, the reinforcement element can be a single reinforcement element. Here, the flexibility of the reinforcement element can be varied in different ways. For example, the thickness of the reinforcement element can decrease from the outside towards the inside such that the flexibility in an outer area is lower than in an inner area. Moreover, the geometrical shape can be varied. Further, the reinforcement element may comprise discontinued areas or recesses whose densities and/or dimensions vary to produce a correspondingly varying flexibility. Moreover, the material composition can be varied. Of course, the different possibilities for varying the flexibility of the reinforcement element can be combined.

In a particularly preferred embodiment, two or three reinforcement elements are provided which are arranged side by side. An outer reinforcement element thus defines the outer area and has a relatively low flexibility. Accordingly, the flexibility of the reinforcement elements increases towards the inside.

The flexibility of the individual reinforcement elements can be realized as elucidated above. Preferably, the reinforcement elements are made of the same material such that the different flexibilities are realized by the outer shape and the thickness. In particular, the two or three reinforcement elements are arranged at a distance to each other, wherein the distance may be bridged by connecting webs, for example, such that a continuous transition and/or an infinitely variable flexibility is ensured.

The at least one reinforcement element is preferably at least partly, in particular completely, of plate-shaped or disk-shaped configuration. Here, when the bicycle handlebar grip is mounted, the reinforcement element preferably extends essentially towards the bicyclist and thus runs essentially in horizontal direction. Plate-shaped reinforcement elements thus run essentially parallel to the longitudinal axis of the grip element and/or the handlebar. In other words, the corresponding flat reinforcement elements run essentially parallel to the heel of the hand.

In another particularly preferred embodiment of the bicycle handlebar grip according to the present invention, the bicycle handlebar grip comprises a sleeve made from a harder material. Here, the sleeve is in particular completely surrounded by the grip element made of a softer material. This offers the advantage that the material of the grip element can essentially be selected with a view to ergonomic conditions. In particular nonskid materials etc. may be selected. The sleeve is preferably of an essentially cylindrical configuration and runs along the entire length of the bicycle handlebar grip. Since the sleeve is made from a harder material a good stability of the bicycle handlebar grip can be attained. In particular it is possible to clampingly connect the sleeve with the bicycle handlebar. In a particularly preferred embodiment, the sleeve comprises a clamping area having at least one sleeve slot or one groove.

This offers the advantage that with the aid of a clamping means the inner diameter of the sleeve and/or the slot width can be reduced such that the bicycle handlebar grip can be reliably clamped to the handlebar. Here, it is particularly preferred that a clip-shaped clamping means is provided which completely surrounds the sleeve. Further, the clamping means is preferably configured such that it is integrated in the bicycle handlebar grip. Thus the supporting element is preferably configured in such a way that it extends into the clamping area. Thus the outer configuration of the bicycle handlebar grip defines a unit. Proceeding from the clamping means, which is in particular of clip-shaped configuration, a continuous, in particular curved transition to the supporting element is realized.

In the preferred embodiment of the present invention, wherein the bicycle handlebar grip comprises a sleeve, it is further preferred that at least one reinforcement element is connected with the sleeve. If a plurality of reinforcement elements are provided, a corresponding connection need not be realized for all reinforcement elements but may be provided for only some of the reinforcement elements. The connection may be realized by gluing, vulcanizing or the like. If a plurality of reinforcement elements are provided, it is particularly preferred that individual or all reinforcement elements are integrally formed with the sleeve. This configuration considerably facilitates the manufacture since in a first injection molding step the sleeve together with the at least one reinforcement element can be injection-molded from a hard material, for example.

In a further or in a plurality of further injection molding steps, one or a plurality of softer materials are then injection-molded around the sleeve and the at least one reinforcement element.

The flexibility of an outer reinforcement element or an outer area of a reinforcement element can be reduced by connecting this area of the mounted reinforcement element with the clamping means. When the clip-shaped clamping means is used the reinforcement element preferably extends into the slot of the clamping means, wherein a clamping element comprising a screw can then be guided through a bore provided in this area of the reinforcement element. When the sleeve is clampingly fastened to the bicycle handlebar, the reinforcement element is held or possibly even fixed in the slot of the clamping means. Thus the flexibility of the immediately adjoining outer area of the reinforcement element is reduced.

This offers the advantage that, when a plurality of reinforcement elements are provided, these elements cannot only be made from the same material but also have the same wall thickness and the flexibility of the outer reinforcement element is reduced due to a corresponding connection with the clamping means.

In a bicycle handlebar grip provided with a sleeve a reliable connection between the material surrounding the sleeve and/or the at least one reinforcement element can be improved in that preferably the sleeve and/or the at least one reinforcement element comprises recesses which are at least partly filled with the softer material surrounding the sleeve and/or the at least one reinforcement element. Here, it is particularly preferred that the fillings of the sleeve recesses protrude at least partly from an inner surface of the sleeve. This allows tolerances between the inner diameter of the sleeve and the outer diameter of the handlebar to be compensated for in a simple manner. Further, the soft material protruding inwards provides a better connection with the handlebar due to the increase in friction.

### BRIEF DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

FIG. 1 shows a schematic top view of a preferred embodiment of the bicycle handlebar grip according to the present invention, and

FIG. 2 shows a schematic perspective view of a sleeve comprising two reinforcement elements.

### DETAILED DESCRIPTION OF PREFERRED EMBODIMENTS

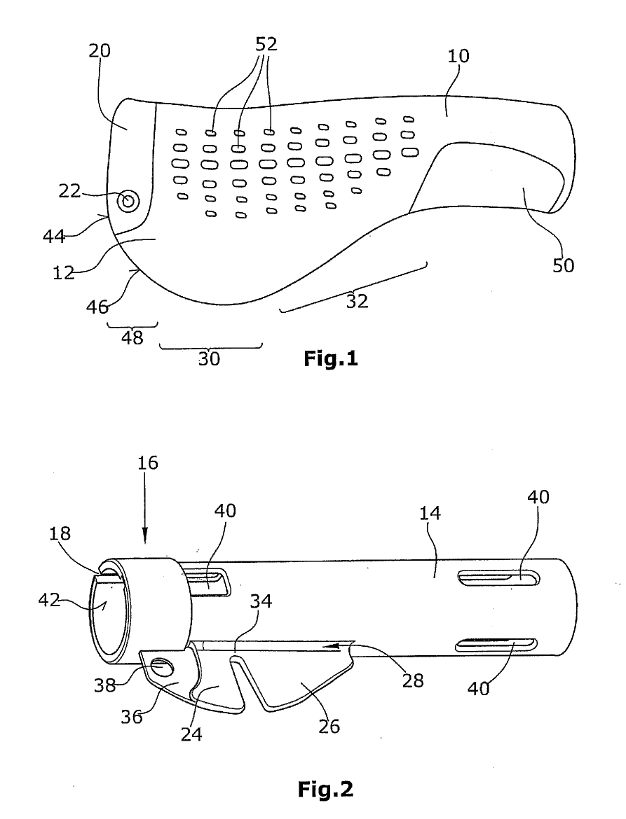

The bicycle handlebar grip according to the present invention comprises a grip element 10. Said grip element 10 is connected with a supporting element 12 for the heel of the hand (hereinafter referred to as supporting element 12). Said supporting element 12 extends towards the bicyclist such that the heel of the hand of the bicyclist can rest on the supporting element 12. The bicycle handlebar grip of FIG. 1, when mounted, is a left bicycle handlebar grip. The bicycle handlebar grip is fastened with the aid of sleeve 14 (FIG. 2) arranged inside the grip element 10 and the grip element 10 is injection-molded around said bicycle handlebar grip. A clamping area 16 of the sleeve 14 comprises a sleeve slot 18. In this area the sleeve 14 is surrounded by a clamping means 20 (FIG. 1). The clamping means which is of essentially ring-shaped configuration like a clip is adapted to be clamped with the aid of a screw 22. Thus in the clamping area 16 the inner diameter of the sleeve is reduced such that the sleeve is clampingly fastened to the handlebar (not shown).

In the illustrated embodiment, two reinforcement elements 24,26 are arranged inside the supporting element 12. A softer plastic material is injection-molded around said reinforcement elements 24,26 made of a hard plastic material. Said plastic material defines the outside of the supporting element 12 (FIG. 1).

In the illustrated embodiment, the reinforcement elements 24,26 serving for reinforcing the supporting element 12 are integrally formed with the sleeve 14. In particular, they form an injection-molded part from a hard plastic material. To ensure a reliable and strong connection between the reinforcement elements 24, 26 and the sleeve 14, transitions with large radii are provided in a connection area 28.

By providing skeleton-type reinforcement elements 24,26 a stable supporting element 12 is realized. Since in the exemplary embodiment a plurality of skeleton-type flat reinforcement elements 24,26 are provided, it is possible to configure areas 30,32 of the supporting element 12 with different flexibilities. Here, the outer area 30 preferably has a lower flexibility than the inner area 32. This can be realized by different geometrical configurations, different materials, different thicknesses etc. of the two reinforcement elements 24,26. Here, the material which is injection-molded around the reinforcement elements 24,26 and usually the sleeve 14 can be selected essentially irrespective of the desired flexibility.

In the illustrated embodiment, the two reinforcement elements 24,26 are connected with each other via a web 34. Said web 34 is provided in the area of the connection between the reinforcement elements 24,26 and the sleeve 14 such that preferably a continuous and uniform connection area is realized between the reinforcement elements 24,26 and the sleeve 14.

In the particularly preferred exemplary embodiment shown of the present invention, the flexibility of the outer reinforcement element 24 is reduced by connecting a projection and/or a portion 36 of the outer reinforcement element 24 with the clamping means 20. In the illustrated embodiment, this is realized in that the projection 36 extends into the slot of the clip-shaped and/or ring-shaped clamping means 20. For closing the clamping means, i.e. for clamping the bicycle handlebar grip to the handlebar, the screw 22 is inserted through the corresponding openings in the clamping means 20 and through the opening 38. Even if the projection 36 has some clearance in the slot of the clamping means 20, the flexibility of the reinforcement element 24 is severely restricted since the reinforcement element 24 bears upon the clip and/or the clamping means 20 even if said reinforcement element 24 is only slightly bent.

In contrast, the inner reinforcement element 26 is not connected with the clamping means 20 and thus offers a larger flexibility.

Further, the sleeve 14 and possibly also the reinforcement elements 24,26 may comprise recesses 40. Through said recesses 40 material enters the inside when said material is injection-molded around the sleeve 14 and the reinforcement element 24,26. The fillings so produced preferably protrude from an inside 42 of the sleeve 14. Thus tolerances between the inner diameter of the sleeve 14 and the outer diameter of the handlebar can be compensated for. Especially because of the potentially higher friction of the material entering the recesses 40 reliable clamping to the bicycle handlebar can be ensured.

It is particularly preferred that the outer configuration of the bicycle handlebar grip allows the clamping means 20 to be integrated in the bicycle handlebar grip. An outside 44 (FIG. 1) of the clamping means 20 thus continuously transitions into an outside 46 of the supporting element 12. To ensure smooth transition the supporting element 12 comprises a projection 48 which extends in the longitudinal direction of the bicycle handlebar grip and into the clamping area.

Since provision of a sleeve 14 and the inner skeleton-type reinforcement elements 24,26 allows the outer configuration and/or the envelope of the bicycle handlebar grip to be freely selected with regard to the material, it is further possible to configure and/or fill areas 50 with further materials. Moreover, surface structures, such as groove-shaped protuberance recesses 52 etc., can be provided.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A bicycle handlebar grip, in particular for mountain bikes and/or trekking bikes, comprising
a grip element (10), and
a supporting element (12) for the heel of the hand connected with said grip element (10),
wherein
said supporting element (12) for the heel of the hand comprises areas (30,32) of different flexibilities.

2. The bicycle handlebar grip according to claim 1, wherein the outer area (30) has a lower flexibility than the inner area (32).

3. The bicycle handlebar grip according to claim 1, wherein inside the supporting element (12) for the heel of the hand at least one reinforcement element (24,26) is arranged which essentially determines the flexibility.

4. The bicycle handlebar grip according to claim 3, wherein the at least one reinforcement element (24,26) is at least partly of a plate-shaped configuration and preferably extends horizontally.

5. The bicycle handlebar grip according to claim 1, wherein the grip element (10) surrounds a sleeve (14) which comprises in particular a harder material.

6. The bicycle handlebar grip according to claim 5, wherein in a clamping area (16) the sleeve (14) comprises at least one sleeve slot (18) whose width is adapted to be reduced with the aid of a clamping means (20).

7. The bicycle handlebar grip according to claim 5, wherein at least one reinforcement element (24,26) is connected with the sleeve (14) and is preferably integrally formed with said sleeve (14).

8. The bicycle handlebar grip according to claim 6, wherein at least one reinforcement element (24), when mounted, is connected with the clamping means (20) and in particular extends into a slot of the clamping means (20) which preferably is of a ring-shaped configuration.

9. The bicycle handlebar grip according to claim 3, wherein the sleeve (14) and/or the at least one reinforcement element (24,26) comprises recesses (40) which at least partly are filled with a softer material, in particular the material of the grip element (10) and/or the supporting element (12) for the heel of the hand.

10. The bicycle handlebar grip according to claim 9, wherein the fillings of the sleeve recesses (40) protrude at least partly from an inner surface (42) of the sleeve (14).

11. The bicycle handlebar grip according to claim 6, wherein the supporting element (12) for the heel of the hand extends into the clamping area (16).
